(19) United States
(12) Patent Application Publication
(10) Pub. No.: US 2006/0219120 A1
(43) Pub. Date: Oct. 5, 2006

(54) Method and device for controlling processes during printing

(76) Inventor: Alfons Schuster, Augsburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/569,748

(22) PCT Filed: Aug. 17, 2004
(86) PCT No.: PCT/EP04/09189

§ 371 Date: Feb. 24, 2006

(30) Foreign Application Priority Data
Aug. 28, 2003 (DE) 103 39 651.9

(51) Int. Cl. B41F 33/00

(52) U.S. Cl. 101/484

(57) ABSTRACT

A method for process control during printing includes recording a digital image of a substrate detail and determining a frequency distribution of the gray values of the image points from this image. A minimum of the frequency is defined as the limiting value of the gray value from this frequency distribution in its central range of the gray value. To calculate the half-tone value R of the substrate, those image points which lie on one side of this limiting value are counted as covered and those image points which lie on the other side are counted as free.

The invention relates to a method for process control during printing according to the precharacterizing clause of claim 1 and to an apparatus which is designed for carrying out this method, for image acquisition on a printing substrate, according to the precharacterizing clause of claim 10.

Conventional offset printing plates are manufactured by means of a film. The film can be measured precisely with a commercially available transmission densitometer. During plate copying and developing, a change in the tonal value occurs on the printing forme, which can be kept constant, however. The measuring on the film is thus sufficient for the process control, in conjunction with the stability of the material, exposure and developing.

In contrast, no film exists in processless printing plates or those which can have their images set by laser (computer-to-plate) or digital forme generation in the printing press (computer-to-press). The tonal value on the printing forme cannot usually be detected densitometrically with sufficient precision using a densitometer which is suitable for paper. Here, the contrast ratios are the main problem, to be precise, in particular, in printing formes having smooth, that is to say reflective, surfaces. Although a planimetric analysis by means of a microscope is possible in principle, it is complex in terms of apparatus and time-consuming. The comparability of measured results which have been obtained with different measuring instruments is also a problem. Furthermore, no further-reaching quality parameters can be detected.

In view of this prior art, the object of the invention consists of identifying a method which makes it possible, for process control during printing, to measure half-tone values with great accuracy on different printing substrates, such as printed paper, all types of printing plates, films and, in particular, also on smooth printing formes as are used in digital forme generation in the printing press. A further object of the invention consists in the provision of an image acquisition apparatus, with which suitable images of different printing substrates, in particular also of smooth printing formes with reflective surfaces, can be recorded for carrying out a method of this type.

According to the invention, these objects are achieved by a method having the features of claim 1 and by an apparatus having the features of claim 10. Advantageous refinements are specified in the respective subclaims 2 to 9 and 11 to 18.

The method according to the invention makes it possible to determine the half-tone value of a detail of a printing substrate automatically and with great accuracy using a recorded digital image. The method can be used for all types of substrates, in particular even for those with difficult contrast ratios which lead in a digital image to a gray value distribution with a fuzzy transition from covered to free area. As a result, it makes meaningful comparisons possible between different types of substrates.

Furthermore, in advantageous developments, the method supplies an integral quantitative statement, in the form of the half-tone value variance, about the homogeneity of the half-tone value in a considered detail of a substrate and, in the form of a gray value image, a spatially resolved graphic representation of the deviations in the half-tone value, which makes it possible to make conclusions about the causes of the deviations.

In order for it to be possible to record digital images of sufficient quality for the automatic evaluation in the case of substrates having difficult contrast ratios, the invention provides an image acquisition apparatus, furthermore, the illumination device of which comprises a bright field light source and a dark field light source which can in each case be activated and set separately.

While reflection densitometers usually work with dark field illumination, bright field illumination is to be preferred for measurements on reflective substrates such as smooth printing formes, in order to achieve sufficient contrast. However, measurements cannot be made on nonreflective substrates using bright field illumination of this type alone. The combination of both illumination types makes it possible for both reflective substrates and also, for comparative and calibrating purposes, nonreflective substrates such as, in particular, reference substrates to be measured with the same measuring apparatus. Furthermore, mixed illumination is also possible in order to optimize the contrast.

Light-emitting diodes are advantageously used as light sources, the light of which is conducted via plastic rods which act as light conductors and via deflection elements and diffusing elements to the substrate surface. The spectral composition of the irradiated light can be varied by the provision of a plurality of light-emitting diodes which emit in different colors and can be set separately, in order to optimize the contrast, which is of advantage, in particular, with regard to measurements on colored substrates. The combination of all the components of the apparatus in a compact housing permits both the stationary arrangement in a printing press and mobile use in commissioning and maintenance work.

In the following text, one exemplary embodiment of the invention will be described using the drawings, in which:

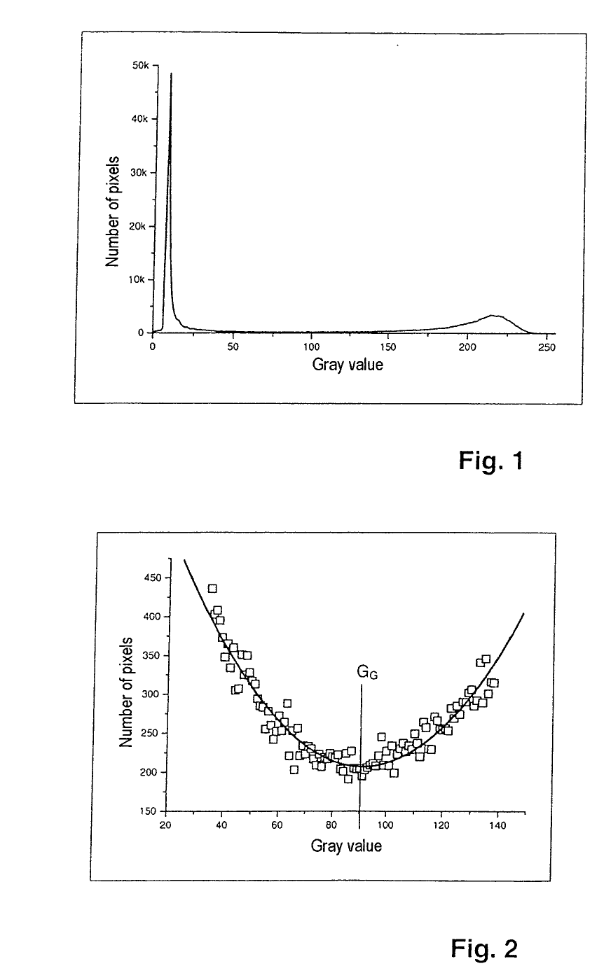

FIG. 1 shows a frequency distribution of the gray value which is measured on a detail of a printing substrate,

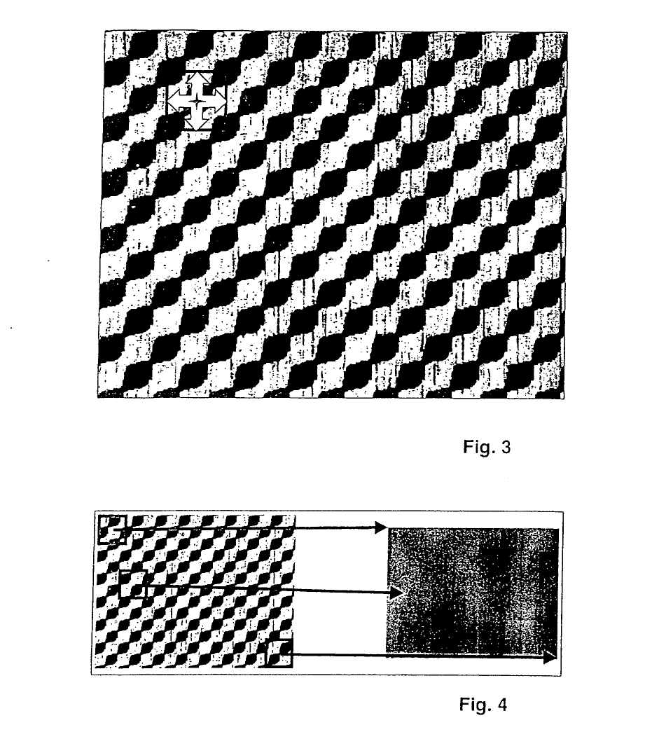

FIG. 2 shows an enlarged detail of the central region of the frequency distribution from FIG. 1,

FIG. 3 shows a digital image of a printing substrate detail,

FIG. 4 shows a schematic drawing of the illustration of a half-tone value variance as a gray value image,

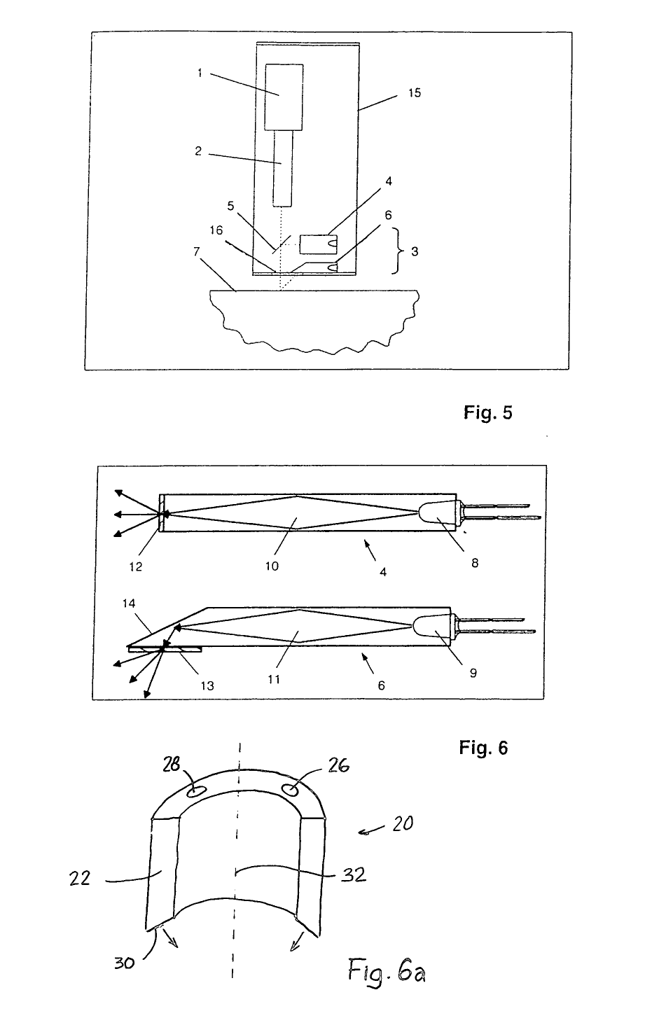

FIG. 5 shows a diagrammatic illustration of an image acquisition apparatus according to the invention,

FIG. 6 shows embodiments of light sources for use in the apparatus from FIG. 5, and

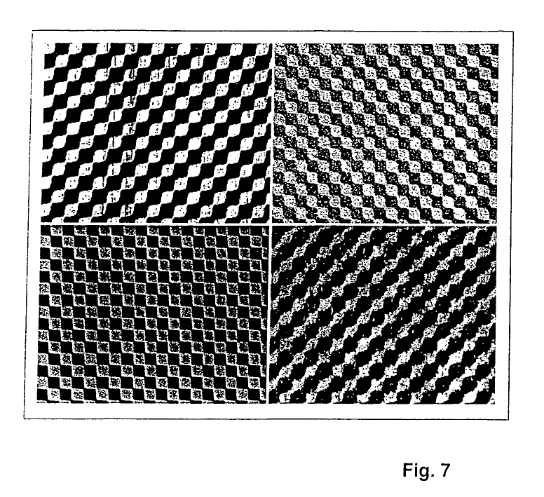

FIG. 7 shows digital images of details of different printing substrates.

The starting point of the method according to the invention is a digital image of a detail of a printing substrate, the quality of which supplies information about the quality of the printing process which is to be monitored. The subject here can be both substrates such as film or paper which can already be measured satisfactorily with conventional densitometers, or else those substrates which cannot be measured sufficiently accurately with conventional measuring instruments, such as printing plates and, in particular, smooth printing formes. One example for the second aspect of the invention, namely an apparatus for acquiring a digital image of this type on any desired printing substrates, will be explained later.

A digital image of the type of interest here comprises a rectangular matrix of image points, also called pixels, of which every one has been assigned a gray value in the form of a digital number during the image recording in a camera module. For example, this gray value consists of an integer which lies between 0 and 255 in the case of a resolution of 8 bits, it being possible, for example, for the gray value 0 to represent a completely black image point and for the gray value 255 to represent a completely white image point, or vice versa.

A characteristic variable which is known per se for characterizing a printed image is what is known as the half-tone value R, also called area coverage. Said value indicates which proportion of the area of a printed image is covered with printing ink during printing. The half-tone value R of a printed image which is present on a printing substrate cannot be determined readily from a digital image which is acquired from the substrate with a camera module, as there are always numerous pixels which overlap edges of raster dots and therefore have a gray value which depends on the respective extent of the overlapping. Furthermore, even on account of imperfections in the illumination and the substrate surface itself, pixels which lie completely in raster dots do not appear completely covered and pixels which lie completely outside raster dots do not appear completely free, that is to say the contrast between covered and free area is always limited.

According to the invention, the half-tone value R is determined via the evaluation of the frequency distribution of the gray values of the acquired, digital image. One example of a frequency distribution of this type is shown in FIG. 1. This is actually a discrete frequency distribution, that is to say a histogram of the gray value which in this case lies between 0 and 255 in accordance with a resolution of 8 bits, the value 0 corresponding to a purely black pixel and the value 255 corresponding to a purely white pixel. The height of the curve above every gray value specifies the number of pixels with this gray value. The curve shown results from connecting the individual points with straight lines.

As can be seen in FIG. 1, the distribution has two pronounced maxima, of which one lies in the lower half of the gray value range and the other lies in its upper half. These two maxima correspond to the covered or the free area of the image. They are always to be expected in the gray value histogram of a digitally acquired printed image and are more pronounced the higher the contrast is between covered and free area.

In order then to define a boundary between these properties within the gray value histogram with its, as it were, continuous transition between the intrinsically binary properties “covered” and “free”, the central region between the two abovementioned maxima is evaluated by means of a compensation curve, which is shown in FIG. 2, which represents the central region of FIG. 1 in enlarged form. As FIG. 2 shows clearly, the frequency distribution of the gray value is intrinsically discrete and, in the range in question, not monotonic with considerable scatter of the individual points around the plotted compensation curve. The use of the gray value with the absolutely lowest frequency as a limiting value in order to distinguish between image points which are to be considered covered and free would therefore not be a sensible procedure as it is too imprecise.

One possible way of defining a compensation curve is to determine a low-order polynomial, in particular a parabola, according to the least squares method; here, it is to be taken note of in every case that the curve is to rise monotonically in the region of interest on both sides of its minimum. Methods for determining compensation curves with secondary conditions are sufficiently known in mathematics per se. For the sake of simplicity, a parabola is preferably used as compensation curve. The curve which is plotted in FIG. 2 is a parabola.

During the calculation of the compensation curve, the question arises of over which range of the gray value the curve is to extend, that is to say which range is to be included in the calculation of the curve. For this purpose, the invention preferably provides for the two abovementioned absolute frequency maxima to be sought first of all and then for the gray value which lies between them and has the absolute minimum of the frequency as the center of the range to be defined, in which the distribution is to be approximated by the compensation curve.

A first criterion which appears sensible for defining the width of the validity range of the compensation curve is half the spacing between the two maxima. This criterion has been used in the example which is shown in FIGS. 1 and 2. It supplies a compensation curve with a satisfactory profile, but only if the minimum lies approximately centrally between the two maxima.

In order for a position of the minimum which lies possibly considerably asymmetrically between the two maxima to be taken into consideration, it is better to determine the spacing of the minimum from the closer of the two maxima and to select it as the width of the validity range of the compensation curve. In the case of this improved criterion, the width of the validity range is largest when the minimum lies exactly centrally between the two maxima, and is then half the spacing between the two maxima. Said width of the validity range becomes smaller, however, the closer the minimum moves to one of the two maxima, that is to say the more asymmetrical the distribution is.

In the example shown (FIG. 2), the minimum G_{G} of the compensation parabola lies at a gray value of 91. All pixels below this value G_{G} are then counted as covered, while all the pixels above it are counted as free. The frequencies of all the gray values below the minimum G_{G} are therefore added up to give a number N₁. The half-tone value R results in the form of a percental ratio of the number of pixels counted as covered with respect to the overall number of pixels, that is to say according to the formula R=(N₁/N_{ges})·100=[N₁/(N₁+N₂)]·100. Here, the number N₂ of the sum of the frequencies of the gray values above the minimum does not need to be determined specially by addition, as the overall number N_{ges}=N₁+N₂ of the pixels can be assumed as known.

A further evaluation can commence with the integral (that is to say, relating to the entire substrate detail) area coverage R which is obtained in this way, namely the determination of the half-tone variance σ_{R}² as a numerical value for the homogeneity of the area coverage. For this purpose, a square unit cell is used, the side length of which is preferably as great as the smallest line pattern spacing of the raster dots on the substrate in the coordinate directions of the digital image, or else can be an integral multiple. If the directions of the raster dot lines on the substrate coincide with the coordinate directions of the pixels of the digital image, the side length of a unit cell of this type thus corresponds exactly to the line pattern spacing of the raster dots on the substrate.

If the line pattern of the substrate is rotated by 45° with respect to the coordinate directions of the digital image, as is the case in the example which is shown in FIG. 3, the side length of the unit cell is increased by the factor \sqrt{2} in comparison with the line pattern spacing of the raster dots on the substrate. The reason for this lies in the fact that, for the sake of simplicity, the unit cell is determined from the periodicity of the gray value profile of the pixels in the coordinate system of the digital image.

Every image point which is at least half a side length of a unit cell away from the edge of the image is then circumscribed with a unit cell of the abovementioned type, as is illustrated at the top left of FIG. 3 for an image point. Here, the unit cell is identified by the illustrated square which is defined by the cross of arrows, and the circumscribed image point is identified by the small cross in the center of the square. The abovementioned relationship between the side length of the unit cell and the line spacing of the raster dots in the case of the line pattern being positioned at 45° with respect to the coordinate system of the digital image can be seen immediately in FIG. 3.

A local half-tone value rᵢ according to the formula rᵢ=(nᵢ₁/N_{E})·100 is calculated for every image point which is spaced apart from the edge sufficiently, using the limiting value G_{G} which was determined for the calculation of the half-tone value R and also using the gray values of the image points which lie within the respective unit cell. In said formula, nᵢ₁ is the number of image points within the respective unit cell with a gray value below G_{G}, and N_{E} is the total number of image points of a unit cell. It goes without saying that a calculation of this type can be carried out only for image points which are at the abovementioned minimum spacing from the image edge, as otherwise the circumscription with a unit cell of said type is not possible.

A local half-tone value rᵢ and its deviation rᵢ−R from the integral half-tone value R is determined for every image point of this type, the calculation expediently being carried out incrementally during processing of the entire image, that is to say those gray values of the departing image points which lie below G_{G} are subtracted and those of the arriving image points are added during every displacement of the unit cell under consideration from one image point to the next. The total substrate detail is then assigned a half-tone value variance σ_{R}² as an integral homogeneity parameter, said half-tone value variance σ_{R}² being calculated according to the rules of mathematical statistics as follows:

$${σ}_{R}^{2} = {\sum }_{i = 1}^{n} \frac{{( {r}_{i} - R )}^{2}}{n - 1} .$$

In this formula, n is the number of image points for which a local half-tone value rᵢ has been calculated, and i is a running index. The greater the value of σ_{R}², the greater the deviations of the half-tone value within the substrate detail under consideration.

Moreover, the local deviation of the half-tone value from its value R which is averaged over the substrate detail under consideration can be converted into a gray value image for every image point which can be circumscribed with a unit cell, which gray value image provides information in a spatially resolved manner about inhomogeneities, such as trends in the writing-track width of the exposer or local exposure deviations. For this purpose, a gray value Gᵢ is calculated as follows for every circumscribable image point:
Gᵢ=G_{M}−ξ·(rᵢ−R).

Here, G_{M} is a mean gray value and ξ is a scaling factor. For example, in the case of a gray value resolution of 8 bits, the mean gray value would be G_{M}=128 and a typical value for the scaling factor would be ξ=50/R. In this case, the mean gray value G_{M}=128 would be assigned to an image point, the local half-tone value rᵢ of which coincides precisely with the integral half-tone value R. An image point, the local half-tone value rᵢ of which is 1% greater than R, would then receive a gray value of 128−50=78.

One example for a conversion of this type of the local deviations of the half-tone value into a gray value image is shown in FIG. 4. In said figure, the digital image of a substrate detail can be seen on the left and the associated gray value image of the deviation of the local half-tone value rᵢ from its mean value R can be seen on the right. Three different unit cells are shown in the left-hand image and the attribution of these unit cells to the associated points of the right-hand image are made clear in each case by arrows. As can be seen from FIG. 4, the dimensions of the right-hand image in both coordinate directions are shorter in each case by the side length of a unit cell than those of the left-hand image, that is to say no conversion takes place for the abovementioned reason for an edge region of the left-hand image having the width of half a unit cell.

The more uniform the raster dots, the more homogeneous the resulting gray area. Although they typically lie only in the range from 1% to 2%, local deviations of the half-tone value are very clearly visible to the human eye from a sufficient distance, that is to say at the normal viewing distance for a printed product, and are perceived as disturbing. Here, it is not possible to localize the problem by means of a microscope, as the local frequency of the deviation is moved out of the sensitive range of the eye during enlargement. By means of the representation according to the invention in the form of a gray value image, the deviations are made accessible to the eye in a spatially resolved manner for the first time or are quantified via the integral homogeneity parameter σ_{R}². It goes without saying that homogeneity tests of the type under discussion here require a homogeneous setpoint profile of the test pattern which is observed on the substrate.

In principle, the unit cell could also be selected to be larger than has been proposed in the above text, which would mean, however, an averaging over a greater area during the calculation of the local half-tone values rᵢ and thus a reduction in the spatial resolution. On the other hand, the dimensions of the unit cell could be reduced and, as a result, the spatial resolution increased somewhat during a rotation of the line pattern of the substrate with respect to the coordinate system of the digital image by a suitable transformation, that is to say by using a correspondingly rotated unit cell.

In order to record digital images of details of different types of printing substrates, which images are suitable for carrying out the above-described method, a universally usable image acquisition apparatus is provided according to a second aspect of the invention. This comprises, first of all, a camera module 1 with a CCD image sensor and a frame grabber or a USB or Firewire interface. The camera module 1 is designed for connection to a computer which is programmed to evaluate the recorded image and on the display screen of which the image can be viewed. A low-noise measuring camera with at least 300 000 pixels (for example as a 640×480 matrix) and 8 bit gray value resolution is preferably used. In order to further reduce the camera noise and to increase the measuring accuracy accordingly, an average is taken pixel by pixel over a large number of digitized images, that is to say preferably from 20 to 100 digitized images, and only the denoised image which has been produced in this way is used for evaluation.

A microscope objective 2 with a great working distance is selected for mapping. The enlargement is selected, depending on the size of the CCD image sensor, in such a way that a region of a few square millimeters, for example 2.5 mm×2 mm, is mapped. This minimizes the measuring error during later evaluation, as a sufficient image resolution is combined with a sufficiently large image detail (on average 100 raster dots depending on the raster). Too low a resolution would mean that raster dots would be acquired only partially and the measuring accuracy would be reduced.

The most important feature of this aspect of the invention is the optimum adaptation of the illumination to the measuring situation. A distinction is made in microscopy between bright field illumination, in which light which is reflected directly from the substrate passes into the objective, and dark field illumination, in which only light which is scattered on the substrate passes into the objective. With regard to flexible illumination of the different types of substrates and to the camera arrangement used, the illumination device 3 according to the invention combines a plane glass illuminator 4, 5 with a directly illuminating dark field light source 6.

The plane glass illuminator comprises a light source 4, which emits transversely with respect to the beam path which runs from the substrate 7 to the objective 2, and a partially transparent mirror 5 which is arranged at an angle of 45° in this beam path and diverts the light of the light source 4 onto the substrate 7, where it is reflected partially and shines into the objective 2 through the mirror 5. The dark field light source 6 illuminates the substrate 7 at an angle of 45° with respect to said beam path, with the result that light which originates from this light source 6 can shine into the objective 2 only by scattering on the substrate 7. Depending on the desired illumination situation, the light sources can be switched on individually or together and their intensity can be adjusted, in order to optimize the contrast of the recorded image.

In FIG. 6, a bright field light source 4 which emits straight ahead is shown diagrammatically at the top, and a dark field light source 6 which emits obliquely at approximately 45° is shown diagrammatically at the bottom. The light sources 4 and 6 are of modular construction, in that light-emitting diodes 8 and 9 are fitted and/or adhesively bonded in each case into a rod or bar 10 and 11, respectively, made from transparent plastic, as is available for example under the name “Plexiglas”. The plastic bar 10 or 11 at the same time acts as a holder for the light-emitting diodes 8 and 9, respectively, and as a light conductor, in that a large part of the light which is coupled in is kept in the bar 10 or 11 by total reflection and leaves said bar only at the desired location, as is indicated in FIG. 6.

Given corresponding cross-sectional dimensions of the bar 10 or 11, in each case a plurality of light-emitting diodes 8 or 9 can be arranged next to one another in one or else in both cross-sectional directions of the bar 10 or 11, in order to achieve both a sufficiently high and also uniformly distributed light intensity. Another reason for the arrangement of a plurality of light-emitting diodes 8 or 9 is the combination of different emission colors in order to vary the spectral composition of the irradiated light, which is of interest, in particular, in the case of at least partially colored substrates in order to optimize the contrast. In order for it to be possible to vary the spectral composition, the differently colored light-emitting diodes have to be able to be switched on separately and have their intensity set separately. The use of light-emitting diodes which emit blue has proven advantageous for measuring black raster dots on a reflective metal surface, such as a smooth printing forme has.

In each case one diffuser 12 and 13 in the form of a film is attached to the exit surfaces of the plastic bars 10 and 11, respectively, in order to achieve as uniform an illumination as possible of that detail of the substrate 7 which is recorded by the camera module 1. As an alternative to this, the light can also be scattered at the exit surface by a roughened section of the surface in this region. In order to attain a defined exit angle, the bar 11 of the dark field light source 6 has a surface section 14 which has been bevelled with consideration being taken of the refractive index, that is to say the additional deflection during exit as a consequence of the refraction. Limits are placed on the width of the bars 10 and 11 only by the available installation space.

In order to eliminate the emission of disruptive scattered light as far as possible from the light sources 4 and 6 in the direction of the objective 2, it is expedient to cover the surfaces of the plastic bars 10 and 11 with metal foil, with the exception of the light exit surfaces.

An annular light source which can be arranged coaxially with respect to the objective 2 in a space-saving manner can also be realized by means of a transparent plastic tube. For this purpose, one end surface of the tube is provided with a plurality of holes, into which in each case light-emitting diodes are fitted. The other end surface is bevelled axially symmetrically in such a way that the light which propagates in the longitudinal direction within the tube is deflected towards the center axis during its exit and is focused onto that region of the substrate 7 which is to be illuminated. A tubular light source of this type is suitable, above all, as a dark field light source.

The illumination device 3 is mounted in a housing 15 together with the camera module 1, the objective 2 and an intensity-regulating device (not shown) for the light sources 4, 6, said housing 15 being open or transparent towards the substrate in the passage region 16 of the beam path from the substrate 7 to the objective and from the dark field light source 6 to the substrate.

Examples of digital images of different substrates which have been recorded with an image acquisition apparatus according to the invention are to be seen in FIG. 7. The substrates are as follows: on the top left, a printing forme which was produced digitally in the printing press, as is known under the name “DicoForm”; on the top right, an aluminum printing plate; on the bottom left, a film; and on the bottom right, paper. The bright field illumination was used for the two left-hand recordings, and the system was switched over to dark field illumination for the two right-hand ones. As FIG. 7 shows, images of sufficient quality for automatic evaluation can be obtained of a very wide variety of different substrates with the apparatus according to the invention.

1-18. (canceled)

19. A method for process control during printing, comprising the steps of:
recording a digital image of a substrate detail comprising a portion of a printing substrate;
determining a frequency distribution of gray values of image points of the recorded digital image;
defining, from a central range of the frequency distribution of gray values, the minimum frequency of the frequency distribution of gray values as a limiting value G_{G} of the gray values; and
calculating a half-tone value R of the substrate detail, said step of calculating including counting the image points in the digital image which lie on one side of the limiting value G_{G} as covered and counting the image points in the digital image which lie on the other side of the limiting value G_{G} as free.

20. The method of claim 19, wherein said step of calculating comprises calculating the half-tone value R according to the formula:
R=(N₁/N_{ges})*100,
wherein, N₁ is the number of image points which are counted as covered, and N_{ges} is the overall number of image points.

21. The method of claim 19, wherein said step of defining comprises using a compensation curve adapted to the frequency distribution in the central range of the gray value.

22. The method of claim 19, wherein said step of defining further comprises selecting a range as the central range of the gray value so that a center of the range forms the minimum frequency which lies between respective frequency maxima in the lower half and in the upper half of the frequency distribution of gray values, wherein the width of the range corresponds to the difference between a gray value of the minimum frequency and a gray value of the one of the two maxima that is closer to the minimum frequency.

23. The method of claim 19, further comprising the steps of:
defining a unit cell of the digital image such that a side length of the unit cell is an integral multiple of the smallest line pattern spacing of the raster dots of the substrate in the coordinate directions of the digital image;
circumscribing each image point of the digital image which is at least half the side length of the unit cell away from the edge of the digital image with one of the unit cells; and
calculating a local half-tone value rᵢ for each circumscribed image point using the limiting value G_{G} and also using the gray values of the image points which lie within the respective unit cell.

24. The method of claim 23, further comprising the step of calculating a half-tone value variance _{R}² of the substrate detail using the local half-tone values rᵢ and the half-tone value R of the substrate detail, according to the formula
$${σ}_{R}^{2} = {\sum }_{i = 1}^{n} \frac{{( {r}_{i} - R )}^{2}}{n - 1} ,$$
wherein n is the number of image points for which a local half-tone value rᵢ has been calculated.

25. The method of claim 23, further comprising the step of generating a gray value image for a graphical representation of the local variation of the half-tone value from the local half-tone values rᵢ of the image points and the half-tone value R of the substrate detail, wherein a gray value Gᵢ at every image point in the gray value image is a measure of the deviation of the local half-tone values rᵢ of the respective image point from the half-tone value R of the substrate detail.

26. The method of claim 25, characterized in that the gray value Gᵢ is calculated as claimed in the formula
Gᵢ=G_{M}−ξ·(rᵢ−R),
wherein G_{M} is the mean gray value of the gray value image which is to be generated and is a scaling factor.

27. The method of claim 19, wherein said step of recording a digital image comprises generating the digital image from a large number of individual images of the detail of the printing substrate, wherein gray values for every image point are averaged.

28. An apparatus for image acquisition on a printing substrate, comprising:
an electronic camera module;
an imaging objective which is arranged between said camera module and the printing substrate to be imaged; and
an illumination device for illuminating the printing substrate, said illumination device comprising a bright field light source and a dark field light source, each of said bright field light source and said dark field light source being independently activatable and said each of said bright field light source and said dark field light source having an independently adjustable light intensity.

29. The apparatus of claim 28, wherein said each of said bright field light source and said dark field light source comprise a light-emitting diode and a light conductor.

30. The apparatus of claim 29, wherein at least one of said bright field light source and said dark field light source comprises a plurality of different colored light-emitting diodes, wherein each of said plurality of different colored light-emitting diodes is independently activatable and each of said plurality of different colored light-emitting diodes has an independently adjustable light intensity.

31. The apparatus of claim 29, wherein at least one of said light conductors in said bright field light source and said dark field light source comprises one of a diffuser or a roughened surface at a light exit surface thereof.

32. The apparatus of claim 29, wherein at least one of said light conductors in said bright field light source and said dark field light source is a rod or bar made from transparent plastic.

33. The apparatus of claim 29, wherein said dark field light source comprises a tube-shaped light conductor made from transparent plastic arranged coaxially with respect to said imaging objective.

34. The apparatus of claim 29, wherein said light conductor of said dark field light source comprises a beveled surface section at which the light is deflected towards an exit surface of said light conductor of said dark field light source.

35. The apparatus of claim 28, further comprising a partially transparent mirror arranged in the beam path between the substrate and said imaging objective said transparent mirror coupling in the light of said bright field light source.

36. The apparatus of claim 28, further comprising a housing in which said camera module, said imaging objective, and said illumination device are arranged.
